(19) United States
(12) Patent Application Publication
(10) Pub. No.: US 2025/0173995 A1
(43) Pub. Date: May 29, 2025

(54) IMAGE ANALYSIS METHOD AND IMAGE ANALYSIS APPARATUS

(71) Applicant: VIVOTEK INC., New Taipei City (TW)

(72) Inventor: Shu-Shu Chiu, New Taipei City (TW)

(73) Assignee: VIVOTEK INC., New Taipei City (TW)

(21) Appl. No.: 18/946,961

(22) Filed: Nov. 14, 2024

(30) Foreign Application Priority Data
Nov. 23, 2023 (TW) 112145352

(51) Int. Cl. G06V 10/32; G06V 10/764; G06V 10/77; G06V 10/776; G06V 20/52

(52) U.S. Cl. CPC G06V 10/32; G06V 10/764; G06V 10/7715; G06V 10/776; G06V 20/52

(57) ABSTRACT

An image analysis method is applied to an image analysis apparatus with an operation processor and includes receiving a surveillance image acquired by an image receiver, transforming the surveillance image into a first low frequency image and a plurality of first high frequency images via wavelet transform, transforming the first low frequency image into a second low frequency image and a plurality of second high frequency images via another wavelet transform, applying down sampling process to first high frequency group data generated by the first high frequency images, and applying depth integration to the first high frequency group data after the down sampling process and second high frequency group data generated by the second high frequency images and low frequency group data generated by the second low frequency image for acquiring concatenation data.

### BACKGROUND OF THE INVENTION

### 1. Field of the Invention

The present invention relates to an image analysis method and an image analysis apparatus, and more particularly, to an image analysis method suitable for a night mode and a related image analysis apparatus.

### 2. Description of the Prior Art

A surveillance camera may lose focus and cause the captured image to become blurry due to weather conditions, external forces, or use fatigue. Even if the surveillance camera performs an automatic focusing function, it is difficult to ensure that the surveillance camera completed the automatic focusing function can continuously capture the clear detection image. The conventional surveillance camera analyzes spatial domain information of the detection image to determine a focus state; however, an amount of the spatial domain information of the detection image is huge, which requires a large-capacity memory unit to store related information of the detection image, and further requires complex computation process and lengthy computation time to determine the focus state of the detection image. Another image analysis method transforms the detection image from the spatial domain to the frequency domain for analyzing the focus state, but the high frequency part in the frequency domain is easily effected by noise; if the detection image is in the environment with sufficient illumination, the high frequency part is in the accurate focus state because there is less noise; if the detection image is in the environment with insufficient t illumination, the high frequency part is affected by a large amount of noise, making it difficult to correctly determine the focus state of the detection image. Therefore, design of an image analysis method and a related image analysis apparatus capable of rapidly and accurately determining whether the detection image acquired in the low illumination environment is in the focus state is an important issue in the surveillance camera industry.

### SUMMARY OF THE INVENTION

The present invention provides an image analysis method suitable for a night mode and a related image analysis apparatus for solving above drawbacks.

According to the claimed invention, an image analysis method is applied to an image analysis apparatus with an operation processor. The image analysis method includes receiving a surveillance image acquired by an image receiver, transforming the surveillance image into a first low frequency image and plural first high frequency images via wavelet transform, transforming the first low frequency image into a second low frequency image and plural second high frequency images via another wavelet transform, applying down sampling process to first high frequency group data generated by the plural first high frequency images, and applying depth integration to the first high frequency group data after the down sampling process, second high frequency group data generated by the plural second high frequency images and low frequency group data generated by the second low frequency image for acquiring feature integration data.

According to the claimed invention, an image analysis apparatus includes an operation processor adapted to execute the image analysis method mentioned as above.

The image analysis method and the image analysis apparatus of the present invention can utilize the wavelet transform to transform the original surveillance image into low frequency data and two levels of high frequency data. The low frequency data can be processed by the standardization process, the discrete cosine transform process and the frequency domain feature extraction process to acquire the frequency domain feature that helps classify the focus state, and can further utilize the expansion process to adjust the extracted frequency domain feature, so that its information size can be the same as the size of the frequency domain data for facilitating following integration. High frequency data of different levels can be processed separately, and multiple convolution kernels of different sizes can be further utilized to extract the effective spatial domain feature; the spatial domain feature extracted from the first horizontal high frequency images can be processed by the down sampling process to adjust its size the same as the size of the spatial domain feature extracted from the second horizontal high frequency images. Final, the extracted frequency domain feature and the extracted spatial domain feature can be processed by the depth integration and the fully connected process to output the classification results corresponding to the multiple focus states, thereby achieving a purpose of accurately identifying and classifying the focus state of the surveillance image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image analysis apparatus according to an embodiment of the present invention.

FIG. 2 is a flow chart of an image analysis method according to the embodiment of the present invention.

FIG. 3 is a diagram of a surveillance image applied for the image analysis method according to the embodiment of the present invention.

FIG. 4 is a functional block diagram of an image analysis model according to the embodiment of the present invention.

FIG. 5 is a flow chart of the image analysis method according to another embodiment of the present invention.

FIG. 6 is a functional block diagram of the image analysis model according to another embodiment of the present invention.

### DETAILED DESCRIPTION

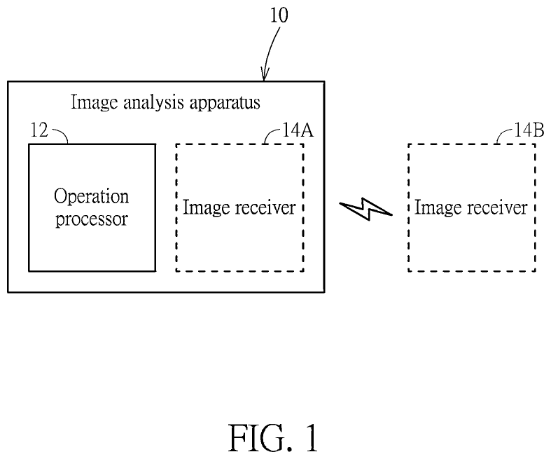

Please refer to FIG. 1. FIG. 1 is a functional block diagram of an image analysis apparatus 10 according to an embodiment of the present invention. The image analysis apparatus 10 can include an operation processor 12 used to execute an image analysis method of the present invention via a surveillance image. The image analysis apparatus 10 can be a surveillance camera optionally including an image receiver 14A; the image receiver 14A can directly capture the surveillance image and transmit the surveillance image to the operation processor 12 for execution of the image analysis method. Further, the image analysis apparatus 10 can be a network video recorder (NVR), a cloud surveillance server, or any device with an image analysis function, which can receive the surveillance image from the external image receiver 14B to execute the image analysis method. Practical application of the image analysis apparatus 10 is not limited to the foresaid embodiment, and depends on a design demand.

The image analysis apparatus 10 of the present invention can be applied for night environments or environments with insufficient illumination. The image analysis apparatus 10 can integrate image analysis in the frequency domain and the multi-dimensional spatial domain. The image analysis method can decompose the surveillance image into two parts: low frequency and high frequency; the low frequency part is classified by using frequency domain feature extraction, and the high frequency part is processed by feature extraction and continuity analysis in the spatial domain to find edge features in the image, which means features of the low frequency part and the high frequency part are extracted respectively in the frequency domain and the spatial domain, and the extracted features in the frequency domain and the spatial domain can be integrated to decide a focus state of the surveillance image. The present invention preferably can transform the surveillance image into the required low frequency image and the required high frequency image via wavelet transform; practical application of the transformation is not limited to the foresaid embodiment. In addition, the present invention can preferably execute two or more wavelet transforms, so as to find out a trend between different dimensional spatial domains to decide the focus state.

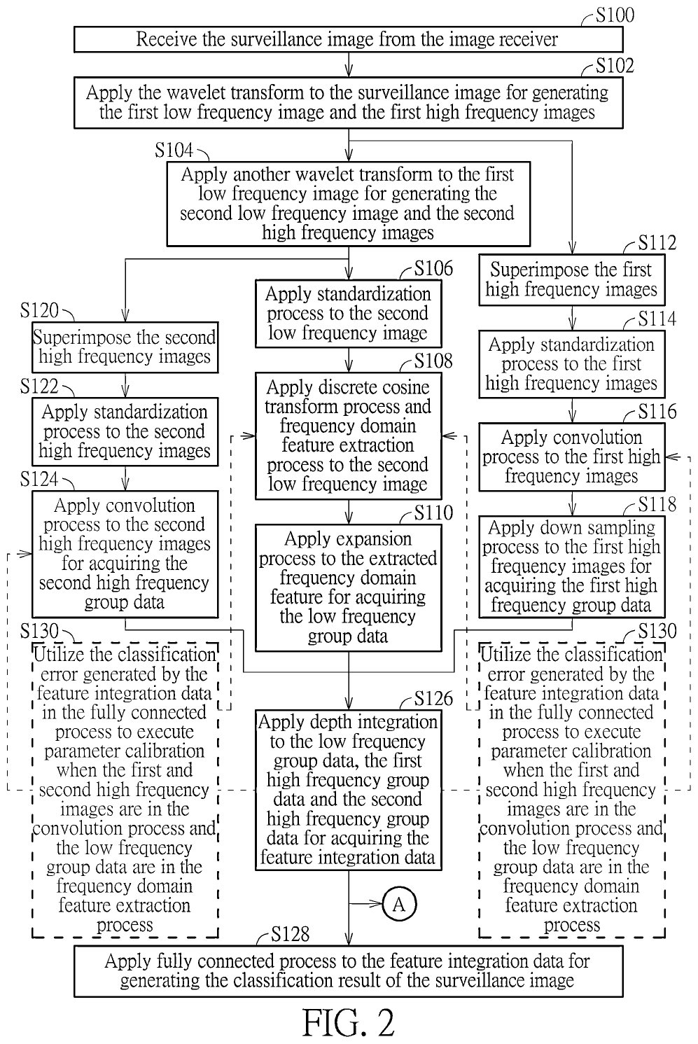

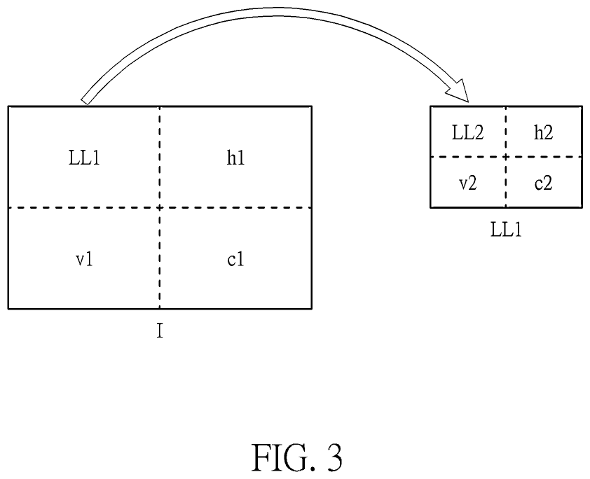

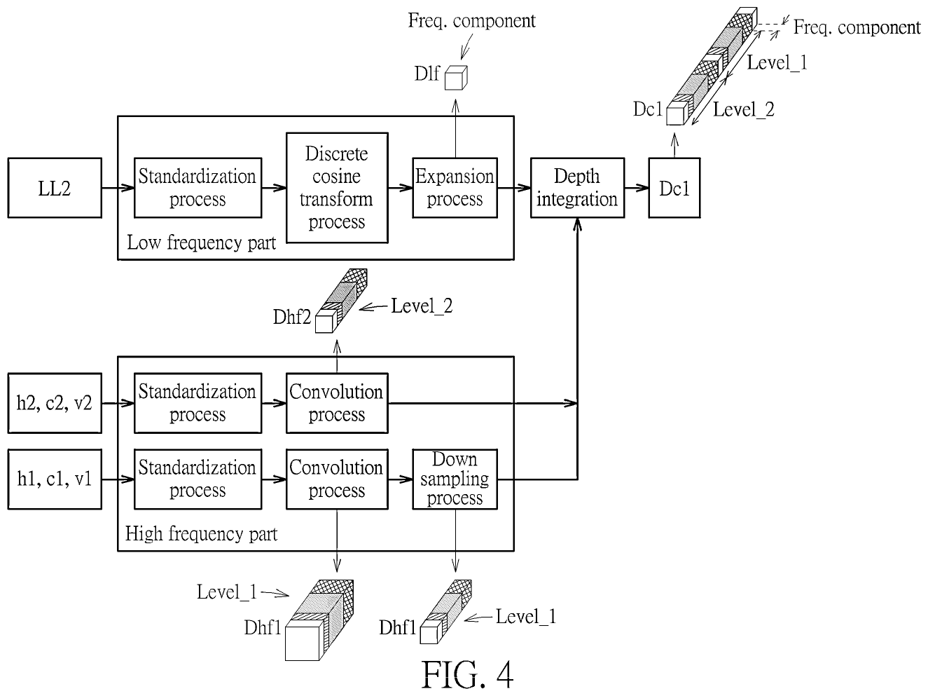

Please refer to FIG. 2 to FIG. 4. FIG. 2 is a flow chart of the image analysis method according to the embodiment of the present invention. FIG. 3 is a diagram of the surveillance image I applied for the image analysis method according to the embodiment of the present invention. FIG. 4 is a functional block diagram of an image analysis model according to the embodiment of the present invention. The image analysis method illustrated in FIG. 2 can be suitable for the image analysis apparatus 10 and the operation processor 12 shown in FIG. 1. First, step S100 and step S102 can be executed to receive the surveillance image I acquired from the image receiver 14A or 14B, and apply the wavelet transform to the surveillance image I for generating a first low frequency image LL1 and plural first high frequency images; the plural first high frequency images can be, but not limited to, a first horizontal difference high frequency image h1, a first vertical difference high frequency image v1 and a first oblique angle difference high frequency image c1.

Then, step S104 can be executed to apply another wavelet transform to the first low frequency image LL1 for generating a second low frequency image LL2 and plural second high frequency images; the plural second high frequency images can be, but not limited to, a second horizontal difference high frequency image h2, a second vertical difference high frequency image v2 and a second oblique angle difference high frequency image c2. As shown in FIG. 3, if the surveillance image I has 256×256 pixels, the first low frequency image LL1 and the first high frequency images h1, v1 and c1 can respectively have 128×128 pixels, and the second low frequency image LL2 and the second high frequency images h2, v2 and c2 can respectively have 64×64 pixels. Therefore, the surveillance image I, the first low frequency image LL1 and the first high frequency images h1, v1, c1, and the second low frequency image LL2 and the second high frequency images h2, v2, c2 can show a size decreasing relationship in an equal proportion.

Then, step S106, step S108 and step S110 can be executed to apply standardization process, discrete cosine transform process, frequency domain feature extraction process and expansion process respectively to the second low frequency image LL2 for acquiring low frequency group data Dlf. The standardization process can exclude frequency response of the frequency domain data outside a specific signal amplitude range, and execute normalization process, so as to dynamically adjust and select a value that can achieve an optimal prediction result for setting as reference for the standardization process, thereby accelerating and stabilizing convergence of the image analysis model. The discrete cosine transform process can have features of lossless compression, frequency independence and the use of real numbers, so that the frequency domain transformation can have preferred computation efficiency, and the frequency domain feature extraction process can be further added to acquire the frequency domain feature that is helpful for focus classification; variation of foresaid process can depend on the design demand. The expansion process can expand depth of the frequency domain according to the design demand; for example, an original size of the second low frequency image LL2 can be (64, 64, 1), which can be transformed into the size (1, 1, c) after the discrete cosine transform process and the frequency domain feature extraction process, and then be expanded to the size of the low frequency group data Dlf, such as (64, 64, c). A symbol “c” is defined as the representative “c” frequency domain features that need to be extracted. It should be mentioned that the image analysis method of the present invention can optionally execute step S106, and sequentially execute step S108 and step S110 after step S106; an optional result of the foresaid order can depend on the design demand.

Then, step S112, step S114, step S116 and step S118 can be executed to superimpose the plural first high frequency images (e.g. at least two of the first horizontal difference high frequency image h1, the first vertical difference high frequency image v1 and the first oblique angle difference high frequency image c1 are superimposed), apply the standardization process and the convolution process to generate first high frequency group data Dhf1, and apply down sampling process to the first high frequency group data Dhf1 for reducing the size of the first high frequency group data Dhf1. For example, the size of the superimposed first high frequency images h1, v1, c1 can be (128, 128, 3), and can be changed to the size (128, 128, j) by the standardization process in step S114 and the convolution process in step S116, and then can be further changed to the first high frequency group data Dhf1 having the size (64, 64, j) by step S118. Step S116 may execute the convolution process, such as a 1×1 or 3×3 or 5×5 convolutional kernel, so as to acquire the edge feature of the surveillance image I covered by the first high frequency group data Dhf1.

Then, step S120, step S122 and step S124 can be executed to superimpose the plural second high frequency images (e.g. at least two of the second horizontal difference high frequency image h2, the second vertical difference high frequency image v2 and the second oblique angle difference high frequency image c2 are superimposed), apply the standardization process and the convolution process to generate the second high frequency group data Dhf2. The size of the superimposed second high frequency images h2, v2, c2 can be (64, 64, 3), and can be changed to the size (64, 64, i) by the standardization process in step S122 and the convolution process in step S124. Therefore, step S126 can then be executed to apply depth integration to the low frequency group data Dlf, the first high frequency group data Dhf1 and the second high frequency group data Dhf2 for acquiring feature integration data Dc1 (e.g. concatenation data). The size of the feature integration data Dc1 can be (64, 64, i+j+c). The foresaid sizes can depend on pixels of the surveillance image I, and parameters of the discrete cosine transform process, the frequency domain feature extraction process and the convolution process; other possible embodiment is omitted herein for simplicity. In addition, the foresaid sizes are examples optionally used for the image analysis method of the present invention, and practical application may be adjusted in accordance with the user's demand.

Final, step S128 can be executed to apply fully connected process to the feature integration data Del for generating a classification result of the surveillance image I, so as to ensure that an applied machine learning model can learn useful features of the frequency domain and the spatial domain and classification rules for maximizing correct classification. A category number of the fully connected process can decide a number of the classification result; by learning a weight of each classification result, the present invention can further decide probability of the surveillance image belonging to each classification result, thereby making classification judgment. Moreover, the image analysis method of the present invention can then execute step S130 to utilize a classification error generated by the feature integration data Del in the fully connected process to execute parameter calibration when the frequency domain feature extraction process is applied for the second low frequency image LL2, the convolution process is applied for the first high frequency images h1, v1, c1, and/or the convolution process is applied for the second high frequency images h2, v2, c2, so as to fine-tune the parameters of each layer of the machine learning model.

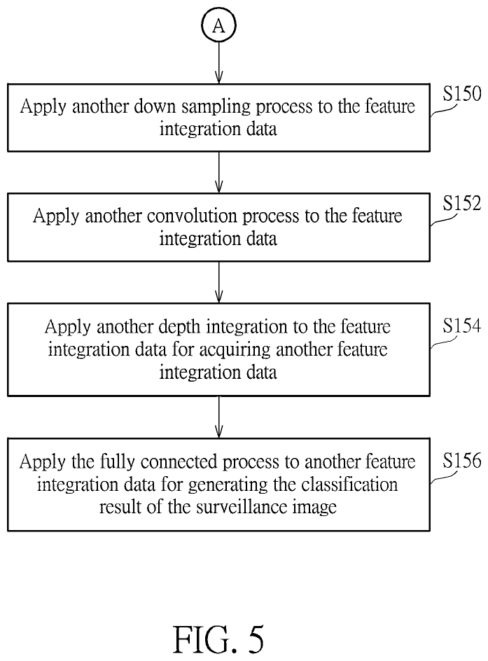

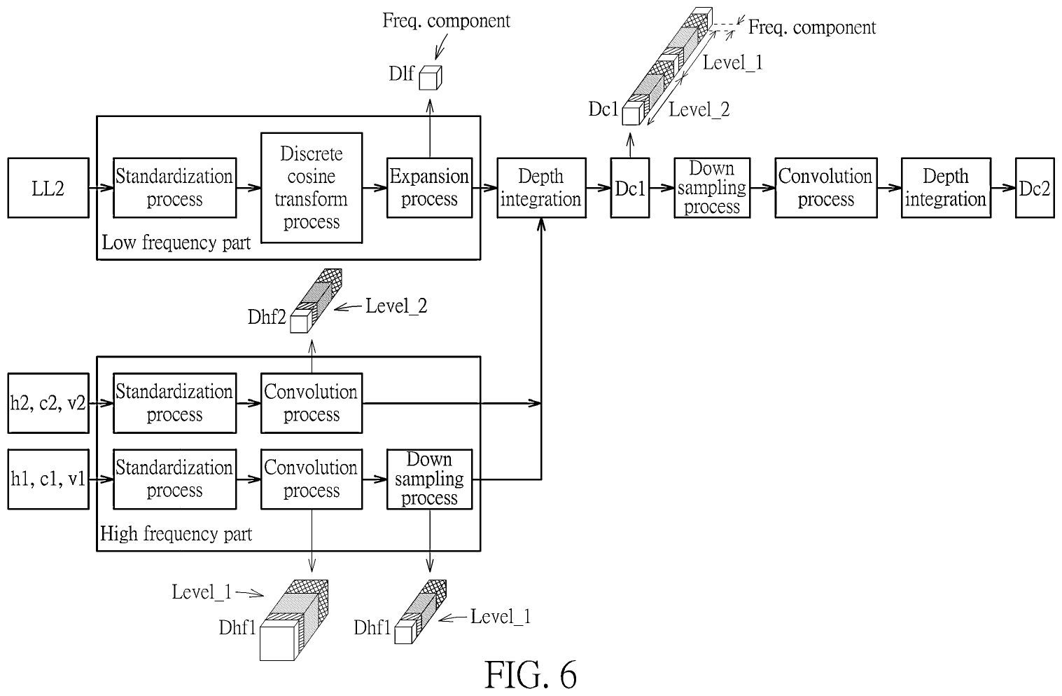

Please refer to FIG. 5 and FIG. 6. FIG. 5 is a flow chart of the image analysis method according to another embodiment of the present invention. FIG. 6 is a functional block diagram of the image analysis model according to another embodiment of the present invention. The image analysis method of this embodiment can execute step S100 to step S126 illustrated in FIG. 2, and can further optionally execute step S150, step S152 and step S154 to apply another down sampling process, the convolution process and the depth integration to the feature integration data Del for acquiring another feature integration data Dc2 when acquiring the feature integration data Dc1 in step S126. Then, step S156 can be executed to apply the fully connected process to another feature integration data Dc2 for generating the classification result of the surveillance image, which has an aim of reducing the size (64, 64, i+j+c) of the feature integration data Del to the size (32, 32, i′+j′+c′) of another feature integration data Dc2, so as to increase accuracy of the classification result. Values of i′, j′ and c′ can be different from values of i, j and c, which depend on the design demand.

Parameter setting of the down sampling process in step S150 can be optionally the same as or different from parameter setting of another down sampling process in step S118. Parameter setting of the convolution process in step S152 can be optionally the same as or different from parameter setting of another convolution process in step S116 or step S124. Size reduction result of the feature integration data is not limited to the foresaid embodiment; excessive reduction may loss effective information in the surveillance image I, and variation of the size reduction can depend on the design demand. In step S156, the classification error generated by another feature integration data Dc2 in the fully connected process can be used to execute the parameter calibration when the frequency domain feature extraction process is applied for the second low frequency image LL2, the convolution process is applied for the first high frequency images h1, v1, c1, the convolution process is applied for the second high frequency images h2, v2, c2, and/or foresaid another feature integration data Dc2, so as to fine-tune the parameters of each layer of the machine learning model for achieving optimal efficiency.

In conclusion, the image analysis method and the image analysis apparatus 10 of the present invention can utilize the wavelet transform to transform the original surveillance image I into low frequency data (such as the first low frequency image LL1 and the second low frequency image LL2) and two levels of high frequency data (such as the first high frequency images h1, v1, c1 and the second high frequency images h2, v2, c2). The low frequency data (such as the second low frequency image LL2) can be processed by the standardization process, the discrete cosine transform process and the frequency domain feature extraction process to acquire the frequency domain feature that helps classify the focus state, and can further utilize the expansion process to adjust the extracted frequency domain feature, so that its information size can be the same as the size of the frequency domain data for facilitating following integration. High frequency data of different levels can be processed separately, and multiple convolution kernels of different sizes can be further utilized to extract the effective spatial domain feature; the spatial domain feature extracted from the first high frequency images h1, v1, c1 can be processed by the down sampling process to adjust its size the same as the size of the spatial domain feature extracted from the second high frequency images h2, v2, c2. Final, the extracted frequency domain feature and the extracted spatial domain feature can be processed by the depth integration and the fully connected process to output the classification results corresponding to the multiple focus states, thereby achieving a purpose of accurately identifying and classifying the focus state of the surveillance image.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image analysis method applied to an image analysis apparatus with an operation processor,
the image analysis method comprising
the operation processor receiving a surveillance image acquired by an image receiver;
the operation processor transforming the surveillance image into a first low frequency image and plural first high frequency images via wavelet transform;
the operation processor transforming the first low frequency image into a second low frequency image and plural second high frequency images via another wavelet transform;
the operation processor applying down sampling process to first high frequency group data generated by the plural first high frequency images; and
the operation processor applying depth integration to the first high frequency group data after the down sampling process, second high frequency group data generated by the plural second high frequency images and low frequency group data generated by the second low frequency image for acquiring feature integration data.

2. The image analysis method of claim 1, further comprising:
the operation processor applying at least one of standardization process, discrete cosine transform process, frequency domain feature extraction process and expansion process to the second low frequency image for acquiring the low frequency group data.

3. The image analysis method of claim 1, wherein the plural first high frequency images comprise a first horizontal difference high frequency image, a first vertical difference high frequency image and a first oblique angle difference high frequency image transformed from the surveillance image via the wavelet transform, the plural second high frequency images comprise a second horizontal difference high frequency image, a second vertical difference high frequency image and a second oblique angle difference high frequency image transformed from the first low frequency image via the wavelet transform.

4. The image analysis method of claim 3, further comprising:
the operation processor superimposing at least two of the first horizontal difference high frequency image, the first vertical difference high frequency image and the first oblique angle difference high frequency image, and generating the first high frequency group data via standardization process and convolution process.

5. The image analysis method of claim 4, wherein the operation processor executes the convolution process to extract an edge feature of the surveillance image from the first high frequency group data.

6. The image analysis method of claim 3, further comprising:
the operation processor superimposing at least two of the second horizontal difference high frequency image, the second vertical difference high frequency image and the second oblique angle difference high frequency image, and generating the second high frequency group data via standardization process and convolution process.

7. The image analysis method of claim 3, further comprising:
the operation processor utilizing a classification error generated by the feature integration data in fully connected process to execute parameter calibration when the first high frequency group data and the second high frequency group data are processed by convolution process and the low frequency group data is processed by frequency domain feature extraction process.

8. The image analysis method of claim 1, wherein the operation processor applies fully connected process to the feature integration data for generating a classification result of the surveillance image.

9. The image analysis method of claim 8, further comprising:
the operation processor applying another down sampling process to the feature integration data; and
the operation processor applying convolution process and the depth integration to the feature integration data after the another down sampling process for acquiring another feature integration data;
wherein the fully connected process is applied to the another feature integration data for generating the classification result.

10. The image analysis method of claim 9, wherein parameter setting of the down sampling process is the same as or different from parameter setting of the another down sampling process.

11. An image analysis apparatus comprising:
an operation processor adapted to receive a surveillance image acquired by an image receiver, transform the surveillance image into a first low frequency image and plural first high frequency images via wavelet transform, transform the first low frequency image into a second low frequency image and plural second high frequency images via another wavelet transform, apply down sampling process to first high frequency group data generated by the plural first high frequency images, and apply depth integration to the first high frequency group data after the down sampling process, second high frequency group data generated by the plural second high frequency images and low frequency group data generated by the second low frequency image for acquiring feature integration data.

12. The image analysis apparatus of claim 11, wherein the operation processor is adapted to further apply at least one of standardization process, discrete cosine transform process, frequency domain feature extraction process and expansion process to the second low frequency image for acquiring the low frequency group data.

13. The image analysis apparatus of claim 11, wherein the plural first high frequency images comprise a first horizontal difference high frequency image, a first vertical difference high frequency image and a first oblique angle difference high frequency image transformed from the surveillance image via the wavelet transform, the plural second high frequency images comprise a second horizontal difference high frequency image, a second vertical difference high frequency image and a second oblique angle difference high frequency image transformed from the first low frequency image via the wavelet transform.

14. The image analysis apparatus of claim 13, wherein the operation processor is adapted to further superimpose at least two of the first horizontal difference high frequency image, the first vertical difference high frequency image and the first oblique angle difference high frequency image, and generate the first high frequency group data via standardization process and convolution process.

15. The image analysis apparatus of claim 14, wherein the operation processor wherein the operation processor is adapted to further execute the convolution process to extract an edge feature of the surveillance image from the first high frequency group data.

16. The image analysis apparatus of claim 13, wherein the operation processor is adapted to further superimpose at least two of the second horizontal difference high frequency image, the second vertical difference high frequency image and the second oblique angle difference high frequency image, and generate the second high frequency group data via standardization process and convolution process.

17. The image analysis apparatus of claim 13, wherein the operation processor is adapted to further utilize a classification error generated by the feature integration data in fully connected process to execute parameter calibration when the first high frequency group data and the second high frequency group data are processed by convolution process and the low frequency group data is processed by frequency domain feature extraction process.

18. The image analysis apparatus of claim 11, wherein the operation processor is adapted to further apply fully connected process to the feature integration data for generating a classification result of the surveillance image.

19. The image analysis apparatus of claim 18, wherein the operation processor is adapted to further apply another down sampling process to the feature integration data, and apply convolution process and the depth integration to the feature integration data after the another down sampling process for acquiring another feature integration data, the fully connected process is applied to the another feature integration data for generating the classification result.

20. The image analysis apparatus of claim 19, wherein parameter setting of the down sampling process is the same as or different from parameter setting of the another down sampling process.
